(19) United States
(12) Patent Application Publication
(10) Pub. No.: US 2005/0036544 A1
(43) Pub. Date: Feb. 17, 2005

(54) Video coding rate control

(76) Inventors: Jennifer Webb, Dallas, TX (US); David P. Magee, Plano, TX (US)

Correspondence Address: TEXAS INSTRUMENTS INCORPORATED, P O BOX 655474, M/S 3999, DALLAS, TX, 75265, US

(21) Appl. No.: 10/917,980

(22) Filed: Aug. 13, 2004

Related U.S. Application Data
(60) Provisional application No. 60/495,543, filed on Aug. 15, 2003.

(51) Int. Cl. H04N 7/12

(52) U.S. Cl. 375/240.03; 375/240.2; 375/240.24

(57) ABSTRACT

The quantizer parameter for video encoding of the H.263 or MPEG-4 type updates in response to buffer discrepancy adapts to the targeted number of bits per frame, and saturates the maximum change of the quantizer parameter.

### CROSS-REFERENCE TO RELATED APPLICATIONS

The present application claims priority from provisional patent application No. 60/495,543, filed Aug. 15, 2003.

### BACKGROUND

The present invention relates to video coding, and more particularly to block-based video coding such as H.263 and MPEG-4.

Various applications for digital video communication and storage exist, and corresponding international standards have been and are continuing to be developed. Low bit rate communications, such as, video telephony and conferencing, led to the H.261 standard with bit rates as multiples of 64 kbps. Demand for even lower bit rates resulted in the H.263 standard.

Block-based video compression with discrete cosine transforms (DCT), such as in the H.261, H.263, MPEG-1, MPEG-2, and MPEG-4 standards, decompose a picture into macroblocks where each macroblock contains four 8×8 luminance blocks plus two (or more) 8×8 chrominance blocks. With 8-bit integer values, conversion to luminance and chrominance yields pixel values in the range −256 to +255.

There are two kinds of coded macroblocks. An INTRA-coded macroblock is coded independently of previous reference frames. In an INTER-coded macroblock, the motion compensated prediction block from the previous reference frame is first generated for each block (of the current macroblock), then the prediction error block (i.e. the difference block between current block and the prediction block) is encoded.

For INTRA-coded macroblocks, the first (0,0) coefficient in an INTRA-coded 8×8 DCT block is called the DC coefficient, the rest of 63 DCT-coefficients in the block are AC coefficients; while for INTER-coded macroblocks, all 64 DCT-coefficients of an INTER-coded 8×8 DCT block are treated as AC coefficients. The DC coefficients may be quantized with a fixed value of the quantization parameter, whereas the AC coefficients have quantization parameter levels adjusted according to the bit rate control which compares bit used so far in the encoding of a picture to the allocated number of bits to be used.

FIG. 2 depicts the functional blocks of typical DCT-based video encoding. In order to reduce the bit-rate, 8×8 DCT is used to convert the 8×8 blocks (luminance and chrominance) into the frequency domain. Then, the 8×8 blocks of DCT-coefficients are quantized, scanned into a 1-D sequence, and coded by using variable length coding (VLC). For predictive coding in which motion compensation (MC) is involved, inverse-quantization and IDCT are needed for the feedback loop. Except for MC, all the function blocks in FIG. 2 operate on an 8×8 block basis. The rate-control unit in FIG. 2 is responsible for producing the quantizer scale (quantizer parameter, QP) according to the target bit-rate and buffer-fullness to control the DCT-coefficients quantization unit. Indeed, a larger quantizer scale implies more vanishing and/or smaller quantized coefficients which means fewer and/or shorter codewords. For both H.263 and MPEG-4 the QP lies in the range 1 to 31; for MPEG-2 the (default) quantization level depends upon the DCT coefficient and is given by an 8×8 matrix of integer quantization levels scalar-multiplied by QP/32.

Telenor (Norwegian telecom) made an encoding implementation for H.263 (Test Model Near-term 5 or TMN5) publicly available, and this implementation has been widely adopted including use for MPEG-4. The Telenor rate control includes the function UpdateQuantizer( ) which generates a new quantizer step size based on the bits used up to the current macroblock in a picture and the bits used by the prior picture. The function should be called at the beginning of each row of macroblocks (slice), but it can be called for any macroblock.

However, the Telenor encoder has blockiness problems with low frame rate transmissions.

### SUMMARY OF THE INVENTION

The present invention provides a quantizer update to avoid a problem discovered in the rate control of the Telenor-type encoder by adapting to the target frames per second.

### BRIEF DESCRIPTION OF THE DRAWINGS

FIG. 1 is a flow diagram.

FIG. 2 is a functional block diagram of block-based encoding with DCT and motion compensation.

### DESCRIPTION OF THE PREFERRED EMBODIMENTS

1. Overview

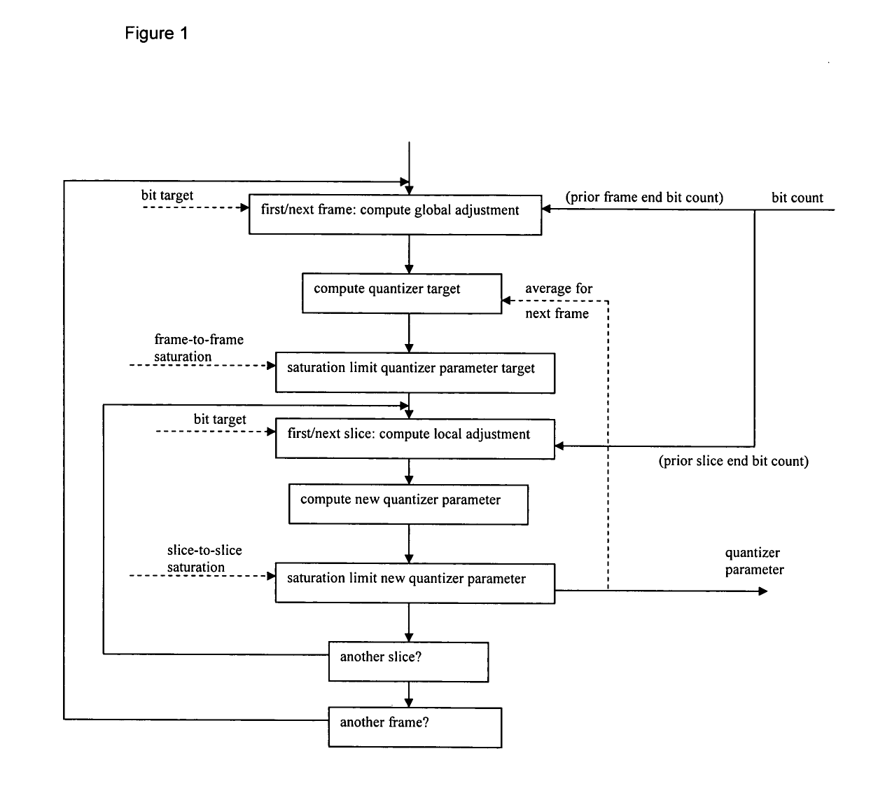

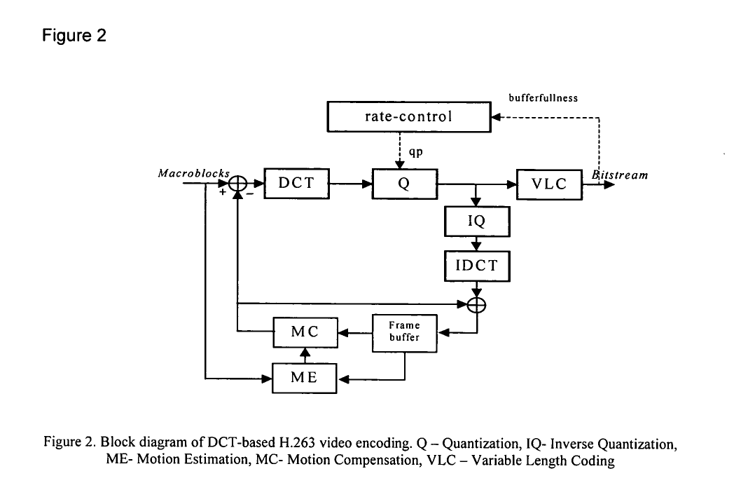

The preferred embodiment video encoding methods reveal and fix a low frame rate problem in encoders like the widely-used Telenor encoder with regard to updating the quantization level (quantizer parameter). FIG. 1 is a flow diagram for a preferred embodiment method which uses a bits per frame variable and provides a saturation for the quantizer parameter change. FIG. 2 is a functional block diagram of an encoder which can incorporate the preferred embodiment methods.

Preferred embodiment systems perform preferred embodiment methods with digital signal processors (DSPs) or general purpose programmable processors or application specific circuitry or systems on a chip (SoC) such as both a DSP and RISC processor on the same chip with the RISC processor controlling. Programs could be stored in memory in an onboard ROM or external flash EEPROM for a DSP or programmable processor to perform the signal processing of the preferred embodiment methods. Analog-to-digital converters and digital-to-analog converters provide coupling to the real world, and modulators and demodulators (plus antennas for air interfaces) provide coupling for transmission waveforms. The encoded video, together with voice, can be packetized and transmitted over networks such as the Internet and/or cellular phone networks.

2. First Preferred Embodiment

First consider the Telenor encoder rate control UpdateQuantizer function for adjusting the quantization step size for DCT coefficients at a macroblock during encoding of a frame in H.263 (or analogously for MPEG-4). The function computes a discrepancy between the number of bits projected to have been used encoding the preceding macroblocks of the frame and the number of bits used in the prior frame. Then a quantizer adjustment is computed from the discrepancy. In particular, the following selective code illustrates the quantizer parameter (QP) updating:

/* rate control static variables */

| | |
|---|---|
| static float B_prev; | /* number of bits spent for the previous frame */ |
| static float B_target; | /* target number of bits/picture */ |
| static float global_adj; | /* due to bits spent for the previous frame */ |

```
int InitializeQuantizer(int pict_type, float bit_rate, float target_frame_rate, float QP_mean)
        /* QP_mean = mean quantizer parameter for the previous picture */
{
  int newQP;
  if (pict_type == PCT_INTER) {
    B_target = bit_rate / target_frame_rate;
        /* compute bit discrepancy forthe previous picture */
    if (B_prev != 0.0) {
      global_adj = (B_prev − B_target) / (2*B_target);
    }
    else {
      global_adj = (float)0.0;
    }
    newQP = (int)(QP_mean * (1 + global_adj) + (float)0.5);
        /* the addition of 0.5 provides round-off for conversion to integers */
    newQP = mmax(1, mmin(31,newQP));
  }
  return newQP;
}
int UpdateQuantizer(int mb, float QP_mean, int pict_type, float bit_rate, int mb_width, int mb_height, int
bitcount)
        /* mb = macroblock index number in the current picture*/
        /* QP_mean = mean quantizer parameter for the previous picture */
        /* bitcount = total number of bits used until now in the current picture */
{
  int newQP=16;
  float local_adj, discrepancy, projection;
  if (pict_type == PCT_INTRA) {
    newQP = 16;
  }
  else if (pict_type == PCT_INTER) {
    /* compute expected number of bits by fraction of macroblocks already encoded */
    projection = mb * (B_target / (mb_width*mb_height));
    /* measure discrepancy between bits coded so far and projection */
    discrepancy= (bitcount − projection);
    /* scale */
    local_adj = 12 * discrepancy / bit_rate;
    newQP = (int)(QP_mean * (1 + global_adj + local_adj) + 0.5);
        /* the update equation for newQP */
  }
  newQP = mmax(1,mmin(31, newQP));
  return newQP;
}
```

Thus the foregoing has the following four main steps to compute the update of the quantizer parameter, QP:
(1) projection=mb*(B_target/(mb_width*mb_height)); where mb is the number of the macroblock, B_target is the targeted number of bits per frame, mb_height and mb_width are the number of rows and columns of macroblocks in the frame. Thus projection is simply B_target multiplied by the fraction of macroblocks already encoded; this reflects the projected bits added to the bitstream buffer.
(2) discrepancy=(bitcount-projection); where bitcount is the number of bits already used encoding the already-encoded macroblocks of the frame; thus discrepancy may be either positive or negative and measures discrepancy from the projected.
(3) local_adj=12*discrepancy/bit_rate; local_adj will be a scale for changing the quantization parameter, QP; bit_rate is the number of bits per second and 12 appears to be a compromise between 10 and 15 which are the typical frame rates for low bit rate transmission.
(4) newQP=(int)(QP_mean*(1+global_adj +local_adj)+0.5); and newQP is the updated QP; QP_mean is the average QP for the prior frame and global_adj is an adjustment due to the final bit discrepancy of the prior frame defined above: global_adj=(B_prev-B_target)/(2*B_target).

In contrast, the preferred embodiment quantizer update method follows the foregoing except it replaces the local_adj with:

(3′) local_adj=discrepancy/B_target; This is similar to the preceding in that B_target=bit_rate/frame_rate, and thus

(3′) local_adj=discrepancy*frame_rate/bit_rate; Hence, for a frame_rate of 12 (apparently a compromise between rates of 10 and 15 frames/second) the preferred embodiment local_adj equals the foregoing local_adj of (3). However, for low frames rates such as 5 frames per second, the preferred embodiment local_adj is much smaller than the local_adj of (3) and gives better performance. Conversely, for high frame rates such as 30 frames per second, the preferred embodiment local_adj is much larger, and can respond faster to avoid frame skips. (Presumably, a low frame rate is selected when higher spatial quality is preferred, and a high frame rate is selected when smooth motion is preferred.)

As an example, presume a low frame rate of 5 fps with a low bit rate (for video) of 20 kbps (bit_rate=20000), this implies a target of 4000 bits per frame (B_target=4000). Then for projected bit discrepancies of ±500 bits (discrepancy =±500) the local_adj of (3) equals 12*(±500)/20000=±0.3; whereas, the preferred embodiment (3′) gives local_adj=±500/4000=±0.125. Thus ignoring global_adj, using (3) for local_adj gives newQP≅1.3*QP_mean or 0.7*QP_mean; whereas, the preferred embodiment gives newQP≅1.125*QP_mean or 0.875*QP_mean, a much smaller adjustment. Indeed, if QP_mean were equal to 20, then (3) leads to newQP=26 or 14, but (3′) gives newQP=23 or 18. At 5 fps, a big adjustment between rows of macroblocks is more visible than at 10 or 15 fps, because the frame persists longer at 5 fps.

For a second example, presume a high frame rate of 30 fps with a higher bit rate (for video) of 1.5 Mbps (bit_rate =1500000), this implies a target of 50000 bits per frame (B_target=50000). Then for projected bit discrepancies of ±10000 bits (discrepancy=±10000) the local_adj of (3) equals 12*(±10000)/1500000=±0.08; whereas, the preferred embodiment (3′) gives local_adj=±10000/50000=±0.2. Thus ignoring global_adj, using (3) for local_adj gives newQP≅1.08*QP_mean or 0.92*QP_mean; whereas, the preferred embodiment gives newQP≅1.2*QP_mean or 0.8*Q_mean, a larger adjustment. Indeed, if QP_mean were equal to 20, then (3) leads to newQP=22 or 18, but (3′) gives newQP=24 or 16. Because at 30 fps, each frame persists a shorter period of time, a faster adjustment in QP may be less visible, and it may help to avoid frame skips and maintain the high frame rate.

The following table illustrates results from encoding two different film sequences (480×272 and 640×352 resolution with 3560 and 2500 total frames, respectively, at 30 fps) with three different modifications of the Telenor rate control method together with the preferred embodiment applied to each of the three modified rate control methods. The encoding is for MPEG-4 simple profile with periodic I frames.

| | Rate control method | period | PSNR-Y (dB) | Frames | comment |
|---|---|---|---|---|---|
| 1 | First | 30 | 45.49 | 3532 | 28 skip frames |
| | First with preferred embodiment | 30 | 45.50 | 3553 | 7 skip frames |
| | Second | 30 | 45.40 | 3528 | 32 skip frames |
| | Second with preferred embodiment | 30 | 45.46 | 3553 | 7 skip frames |
| | First | 2 | 43.27 | 3540 | 20 skip frames |
| | First with preferred embodiment | 2 | 43.08 | 3551 | 9 skip frames |
| | Third | 2 | 43.01 | 3504 | 56 skip frames |
| | Third with preferred embodiment | 2 | 42.88 | 3516 | 44 skip frames |
| 2 | First | 30 | 44.72 | 2487 | 13 skip frames |
| | First with preferred embodiment | 30 | 44.61 | 2496 | 4 skip frames |
| | Second | 30 | 44.57 | 2489 | 11 skip frames |
| | Second with preferred embodiment | 30 | 44.55 | 2494 | 6 skip frames |
| | First | 2 | 40.74 | 2495 | 5 skip frames |
| | First with preferred embodiment | 2 | 40.46 | 2497 | 3 skip frames |
| | Third | 2 | 40.22 | 2500 | 0 skip frames |
| | Third with preferred embodiment | 2 | 40.19 | 2500 | 0 skip frames |

The “period” column indicates the periodicity of I frames, the “PSNR-Y” column indicates the peak signal-to-noise ratio for the luminance, the “frames” column shows the number of frames actually encoded, and the “comments” column shows the number of frames skipped. The more rapid QP adjustment of the preferred embodiments allows fewer frames to be skipped but at the cost of a smaller PSNR for some sequences.

3. Format

Note that the foregoing was cast in floating point. The analogous statements for fixed point with local_adj in Q10 format (ten fractional bits) would be:

(3) local_adj=(1024*12*discrepancy)/bit-rate;

(4) newQP=((QP_mean*(1024+global_adj+local_adj)/1024+512)/1024; and the preferred embodiment new local_adj computation:

(3′) local_adj=(1024*discrepancy)/B_target);

4. Saturation Preferred Embodiments

Further preferred embodiment methods provide saturators to limit the change in QP from slice (e.g., a row of macroblocks) to slice and from frame to frame. In particular, define Arg_delQP_max_slice and Arg_delQP_max_frame as saturators to limit the change in QP from slice to slice and frame to frame, respectively. Typical values could be: Arg_delQP_max_slice=1 and Arg_delQP_max_frame=5 for low frame rates and larger for high frame rates. The preferred embodiments use the variable QP_frame which is the targeted new QP for the current frame derived from adjusting the preceding frame average QP by the final bit discrepancy expressed as global_adj:

QP_frame=(int)(QP_mean*(1+global_adj)+0.5);

The preferred embodiments apply the following steps after the computation of newQP in (4) for frame-to-frame saturation:

```
  if (QP_frame − QP_mean > Arg_delQP_max_frame){
                  QP_frame = QP_mean + Arg_{—}
                  delQP_max_frame;
};
  if (QP_mean − QP_frame > Arg_delQP_max_frame){
                  QP_frame = QP_mean − Arg_delQP_{—}
                  max_frame;
};
```

And then for slice-to-slice saturation (to skip frame-to-frame saturation just use the unadjusted QP_frame):

```
  if (QP_frame − newQP > Arg_delQP_max_slice){
                  newQP = QP_frame − Arg_delQP_{—}
                  max_slice;
};
  if (newQP − QP_frame > Arg_delQP_max_slice){
                  newQP = QP_frame + Arg_delQP_{—}
                  max_slice;
};
```

Thus the saturation limits newQP to a range of values about the target QP_frame for the current frame. This ensures more consistency for QP within a frame, and avoids abrupt changes from frame to frame. Limiting the amount that QP can change may result in additional frame skips, if the buffer becomes too full, but at 5 fps, frame rate is not the highest priority.

Recall that UpdateQuantizer is typically called at the beginning of each slice in a frame; and FIG. 1 illustrates UpdateQuantizer using both saturations.

5. Modifications

The preferred embodiments can be varied while retaining one or more of the features of quantizer parameter control adjusting to a bits-per-frame target and saturation on quantizer parameter change.

For example, the values of the parameters such as Arg_delQP_-max_frame could be varied; the transform coefficients being quantized could be from transforms other than DCT, such as wavelet transforms for I frames; the quantization parameter QP could be used to directly multipy the transform coefficients or to scale a matrix of multipliers for the coefficients; global_adj could be computed in other ways such as a cumulative bit difference over several frames and weighted or even be omitted; and so forth.

1. A method of video encoding, comprising:
(a) providing a bit target for a frame;
(b) computing a discrepancy as the difference between the number of bits used to encode a portion of said frame and a projected number of bits for encoding said portion of said frame;
(c) computing a local adjustment equal to said discrepancy divided by said bit target;
(d) adjusting a quantization parameter using said local adjustment.

2. The method of claim 1, wherein:
(a) said frame is an array of blocks of DCT coefficients.

3. The method of claim 2, wherein:
(a) said projection is said bit target multiplied by the fraction of said blocks in said portion of said frame.

4. The method of claim 1, further comprising:
(a) computing a global adjustment equal to (X-Y)/(2Y) where X is the number of the bits used to encode a prior frame and Y is said bit target; and
(b) said adjusting of step (d) of claim 1 includes using said global adjustment.

5. The method of claim 1, wherein:
(a) said adjusting of step (d) of claim 1 includes a saturation from a target quantization parameter.

6. The method of claim 5, wherein:
(a) said target quantization parameter equals a mean of a quantization parameter for a preceding frame adjusted by said global adjustment.

7. The method of claim 5, wherein:
(a) said target quantization parameter is a mean of a quantization parameter for a preceding frame adjusted by said global adjustment but with a saturation from said mean.
